(19) United States
(12) Patent Application Publication
(10) Pub. No.: US 2014/0359539 A1
(43) Pub. Date: Dec. 4, 2014

(54) ORGANIZING DISPLAY DATA ON A MULTIUSER DISPLAY

(71) Applicant: LENOVO (Singapore) PTE, LTD., New Tech Park (SG)

(72) Inventors: Howard Locker, Cary, NC (US); Michaela Rose Case, Raleigh, NC (US); John Weldon Nicholson, Cary, NC (US); Aaron Michael Stewart, Raleigh, NC (US)

(21) Appl. No.: 13/907,285

(22) Filed: May 31, 2013

(51) Int. Cl. G06F 3/01

(52) U.S. Cl. CPC G06F 3/017
USPC 715/863

(57) ABSTRACT

For organizing display data on a multiuser display, a position module determines a first user position from a first hover presence at a multiuser display. An organization module organizes display data on the multiuser display in response to the first user position.

### BACKGROUND

1. Field

The subject matter disclosed herein relates to multiuser displays and more particularly relates to organizing display data for a multiuser display.

2. Description of the Related Art

The users of traditional small displays and monitors had to be positioned within a relatively small area to view the display, so that a single organization of data relative to the user's position was sufficient. However, large multiuser displays allow a user to interact with the display from many positions.

### BRIEF SUMMARY

An apparatus for organizing display data on a multiuser display is disclosed. A memory stores machine readable code executable by a processor. The machine readable code includes a position module and an organization module. The position module determines a first user position from a first hover presence at a multiuser display. The organization module organizes display data on the multiuser display in response to the first user position. A method and program product also perform the functions of the apparatus.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a perspective drawing illustrating one embodiment of a multiuser display;

FIGS. 2A-B are perspective drawings illustrating embodiments of hover detectors;

FIGS. 3A-C are perspective drawings illustrating embodiments of hover presences on a multiuser display;

FIG. 4 is a schematic block diagram illustrating one embodiment of a hover presence record;

FIGS. 5A-L are drawings illustrating embodiments of organizing display data on a multiuser display;

FIG. 6 is a schematic block diagram illustrating one embodiment of a computer;

FIG. 7 is a schematic block diagram illustrating one embodiment of a data organization apparatus; and

FIG. 8 is a schematic flow chart diagram illustrating one embodiment of a display data organization method.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code. The storage devices may be tangible, non-transitory, and/or non-transmission.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in machine readable code and/or software for execution by various types of processors. An identified module of machine readable code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of machine readable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices, and may exist, at least partially, merely as electronic signals on a system or network. Where a module or portions of a module are implemented in software, the software portions are stored on one or more computer readable storage devices.

Any combination of one or more computer readable medium may be utilized. The computer readable medium may be a machine readable signal medium or a storage device. The computer readable medium may be a storage device storing the machine readable code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A machine readable signal medium may include a propagated data signal with machine readable code embodied therein, for example, in baseband or as part of a carrier wave. Such a propagated signal may take any of a variety of forms, including, but not limited to, electro-magnetic, optical, or any suitable combination thereof. A machine readable signal medium may be any storage device that is not a computer readable storage medium and that can communicate, propagate, or transport a program for use by or in connection with an instruction execution system, apparatus, or device. Machine readable code embodied on a storage device may be transmitted using any appropriate medium, including but not limited to wireless, wire-line, optical fiber cable, Radio Frequency (RF), etc., or any suitable combination of the foregoing.

Machine readable code for carrying out operations for embodiments may be written in any combination of one or more programming languages, including an object oriented programming language such as Java, Smalltalk, C++ or the like and conventional procedural programming languages, such as the “C” programming language or similar programming languages. The machine readable code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by machine readable code. These machine readable code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The machine readable code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The machine readable code may also be loaded onto a computer, other programmable data processing apparatus, or other devices to cause a series of operational steps to be performed on the computer, other programmable apparatus or other devices to produce a computer implemented process such that the program code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and machine readable code. Descriptions of figures may refer to elements described in previous figures, like numbers referring to like elements.

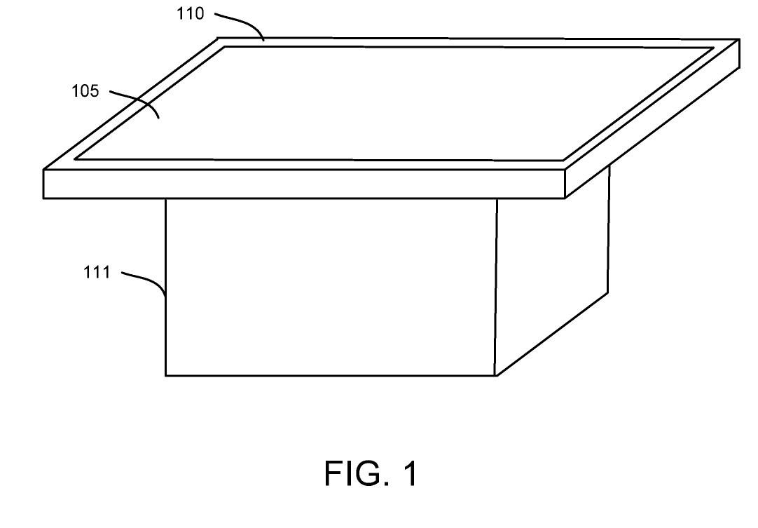

FIG. 1 is a perspective drawing illustrating one embodiment of a multiuser display 105. The multiuser display 105 may be a touchscreen display. In one embodiment, the multiuser display 105 is a HORIZON® display manufactured by Lenovo of Morrisville, N.C.

In the depicted embodiment, the multiuser display 105 is disposed horizontally so the user may interact with the multiuser display 105 as though interacting with the tabletop. The multiuser display 105 may be mounted on a stand 111. Alternatively, the multiuser display 105 may be portable. For example, the multiuser display 105 may be set upon a conference table and/or counter. In one embodiment, the multiuser display 105 is disposed vertically.

In one embodiment, the multiuser display 105 includes a computer. Alternatively, the multiuser display 105 may communicate with an external computer. In one embodiment, the multiuser display 105 is a flexible medium. The multiuser display 105 may be rolled for transport and unrolled for use.

A user may interact with the multiuser display 105 by touching the multiuser display with an electronic pen, a stylus, a finger or multiple fingers, a knuckle, and the like. Alternatively, the user may interact with a multiuser display 105 through virtual keyboard. In addition to detecting the direct contact of the electronic pen, stylus, finger, fingers, typing, or the like, the multiuser display 105 may also detect a hover presence of the user. The hover presence may be a detectable proximity of an object such as an arm to the multiuser display 105 and/or a hover detector of the multiuser display 105. The hover presence may be detected using a detection selected from the group consisting of capacitance detection, resistive detection, optical detection, and acoustic detection.

In the past, small touch screen displays were easily rotated by the user. In addition, the small size and substantially vertical mounting of larger displays limited the positions from which a user could interact with the display. However, a user can interact with the multiuser display 105 from many positions. For example, users could be positioned on any of the sides and/or corners of the multiuser display 105. In addition, multiple users can concurrently interact with the multiuser display 105 from substantially different positions and orientations. As a result, traditional static orientations of display data do not take full advantage of the capabilities of the multiuser display 105.

The embodiments described herein determine a user position from a hover presence relative to the multiuser display 105. The embodiments further organize display data on the multiuser display 105 in response to the user position as will be described hereafter.

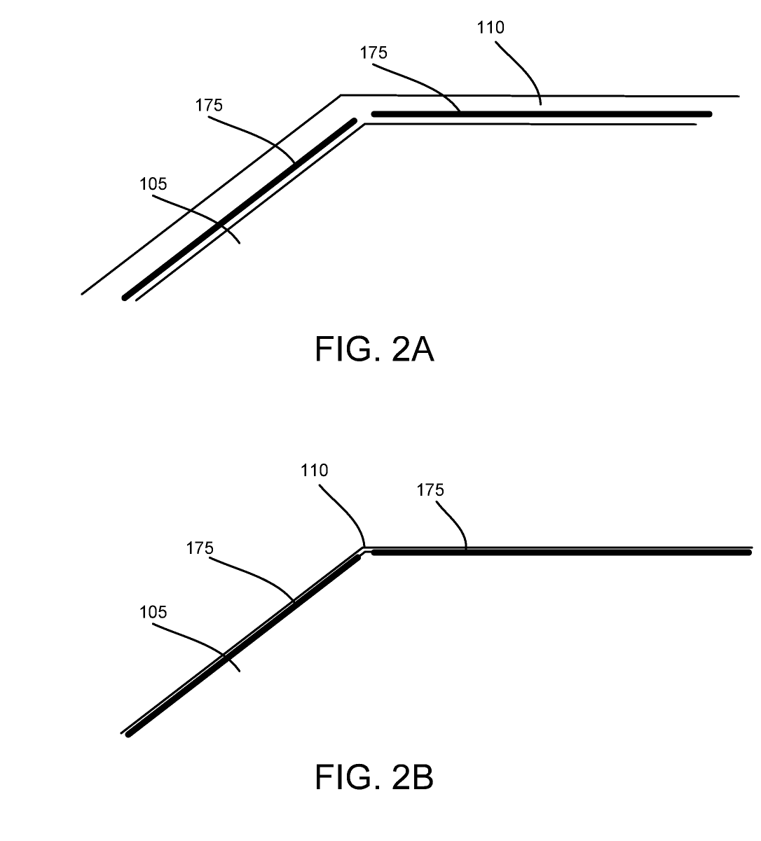

FIGS. 2A-B are perspective drawings illustrating embodiments of hover detectors 175 on the multiuser display 105. In FIG. 2A, the hover detectors 175 are embedded in the edge 110 of the multiuser display 105. The edge 110 may be a bezel. In FIG. 2B, the hover detectors 175 are disposed between the touch screen of the multiuser display 105 and the edge 110. The hover detectors 175 may employ a detection selected from the group consisting of capacitance detection, resistive detection, optical detection, and acoustic detection.

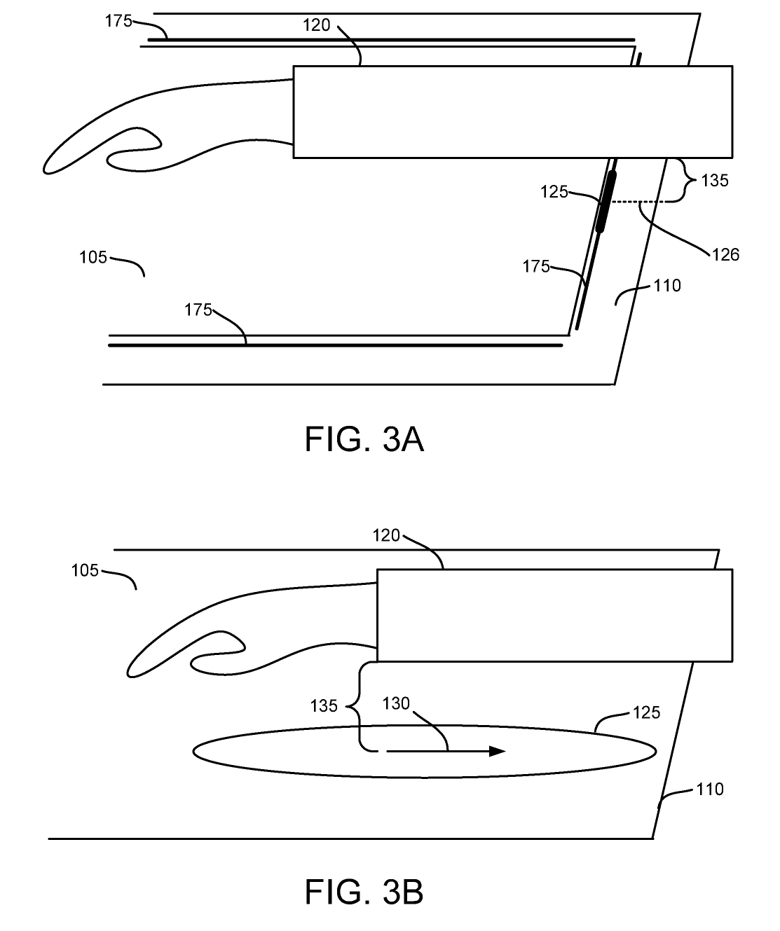

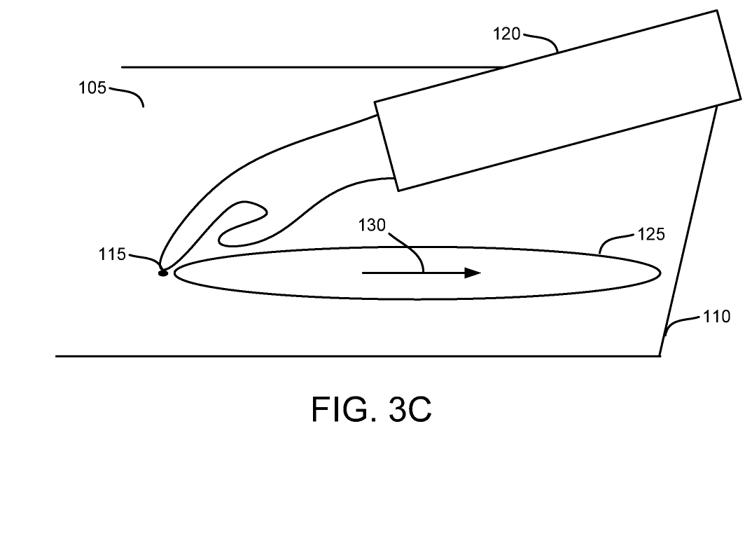

FIGS. 3A-C are perspective drawings illustrating embodiments of hover presences 125 on a multiuser display 105. In FIG. 3A, a proximity object 120, an arm in the depicted embodiment, extends over the edge 110 of the multiuser display 105. The hover presence 125 of the proximity object 120 is detected by at least the portion of the hover detectors 175. In one embodiment, the hover presence 125 of the proximity object 120 is detected when the proximity object 120 is within a proximity distance of 0-30 cm of the hover detector 175. Alternatively, the hover presence 125 of the proximity object 120 is detected when the proximity object 120 is within a proximity distance of 0-90 cm of the hover detector 175.

In one embodiment, a plurality of hover detectors 175 are arrayed along each edge 110 of the multiuser display 105. One or more of the hover detectors 175 may detect the hover presence 125 of the proximity object 120. In one embodiment, an edge vector 126 is calculated for the hover presence 125. The edge vector 126 may be normal to the nearest edge 110 of the multiuser display. In addition, the edge vector 126 may intersect a center of the hover presence 125. The center of the hover presence 125 may be a center-most hover detector 175. Alternatively, the center of the hover presence 125 may be a center of hover presence area that includes each hover detector 175 that detects the hover presence 125.

In FIG. 3B a proximity object 120 is shown in proximity to the multiuser display 105. In one embodiment, the hover presence 125 of the proximity object 120 is detected when the proximity object 120 is within a proximity distance of 0-30 cm of the multiuser display 105. Alternatively, the hover presence 125 of the proximity object 120 is detected when the proximity object 120 is within a proximity distance of 0-90 cm of the multiuser display 105.

The hover presence 125 may include a hover presence area. The hover presence area may comprise a description of each unit area of the multiuser display 105 that detects the proximity object 120. The unit areas may be pixels, touch cells, or the like. The touch cells may be capacitive touch cells. For example, an address of each touch cell of the multiuser display 105 that detects the proximity object 120 may be included in the hover presence area. Alternatively, the touch cells may be resistive touch cells and an address of each touch cell of the multiuser display 105 that detects the proximity object 120 may be included in the hover presence area.

In one embodiment, the hover presence area is determined from acoustic echoes from acoustic detection. Alternatively, the hover presence area may be determined optically. In a certain embodiment, the hover presence area determined from optical scattering. Alternatively, the hover presence area is determined by optically identifying the proximity object 120. The hover presence area may be translated into a pixel list, a touch cell list, and the like.

In one embodiment, a mathematical representation of the hover presence area is calculated. The mathematical representation may be a function that is a fit for the detected hover presence area.

In one embodiment, a hover presence vector 130 is calculated for the hover presence 125. The hover presence vector 130 may be calculated to be in a longitudinal direction of the hover presence area. In addition, a direction of the hover presence vector 130 may be towards the nearest edge of the multiuser display 105. A length of the hover presence vector 130 may be normalized to a unit length. Alternatively, the length of the hover presence vector 130 may be the longitudinal length of the hover presence 125.

In FIG. 3C, the proximity object 120 contacts the multiuser display 105 at a contact location 115. The contact location 115 may be associated with the hover presence 125. In one embodiment, a hover presence 125 that extends from the contact location 115 is associated with the contact location 115. In a certain embodiment, the direction of the hover presence vector 130 may be from the contact location 115 towards the hover presence 125 associated with the contact location 115.

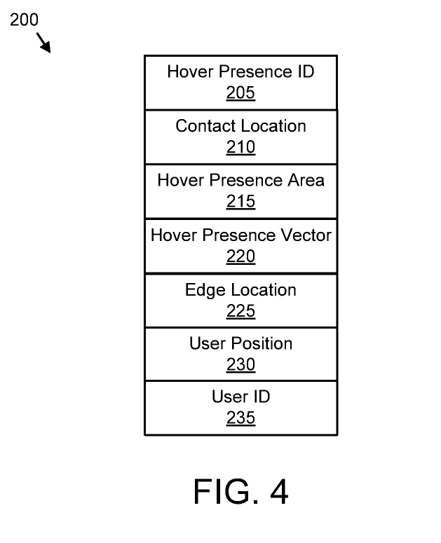

FIG. 4 is a schematic block diagram illustrating one embodiment of a hover presence record 200. The hover presence record 200 may be stored by the multiuser display 105. Alternatively, the hover presence record 200 may be stored on a computer in communication with the multiuser display 105. The hover presence record 200 includes a hover presence identifier 205, a contact location record 210, a hover presence area record 215, the hover presence vector record 220, an edge location record 225, a user position record 230, and a user identifier 235.

The hover presence identifier 205 may uniquely identify the hover presence 125. The contact location record 210 may record the location of the contact location 115. The contact location record 210 may comprise one or more pixel addresses. Alternatively, the contact location record 210 may comprise one or more touch cell addresses. In a certain embodiment, the contact record location 210 may comprise a coordinate pair identifying the location of the contact location 115.

The hover presence area record 215 may record addresses of pixels, touch cells, and the like that comprise the hover presence area of the hover presence 125. Alternatively, the hover presence area record 215 may comprise a mathematical representation of the hover presence area.

The hover presence vector record 220 may record a mathematical representation of the hover presence vector 130. The mathematical representation of the hover presence vector 130 may include the direction and the length of the hover presence vector 130.

The edge location record 225 may identify one or more of the hover detectors 175 detecting the hover presence 125. In one embodiment, a center of the hover detectors 175 detecting the hover presence 125 is recorded. In addition, the edge location record 225 may record the edge vector 126.

The user position record 230 may identify an area adjacent to the multiuser display 105 as a user position. Alternatively, the user position record 230 may identify of volume adjacent to the multiuser display 105 as the user position. In one embodiment, a center of the user position is intersected by the edge vector 126. Alternatively, the center of the user position may be offset from the edge vector 126. In an alternative embodiment, the center of the user position intersects the hover presence vector 130. Alternatively, the center of the user position may be offset from the hover presence vector 130.

The user identifier 235 may uniquely identify the user. The user identifier 235 may include a username, a user identification number, a user password, a biometric identifier, or the like. In one embodiment, the multiuser display 105 may query a user for one or more portions of the user identifier 220 in response to detecting the hover presence 125. The biometric identifier may be a fingerprint, palm print, facial image, retinal image, and the like recorded by the multiuser display 105. Alternatively, the biometric identifier may be retrieved from user data.

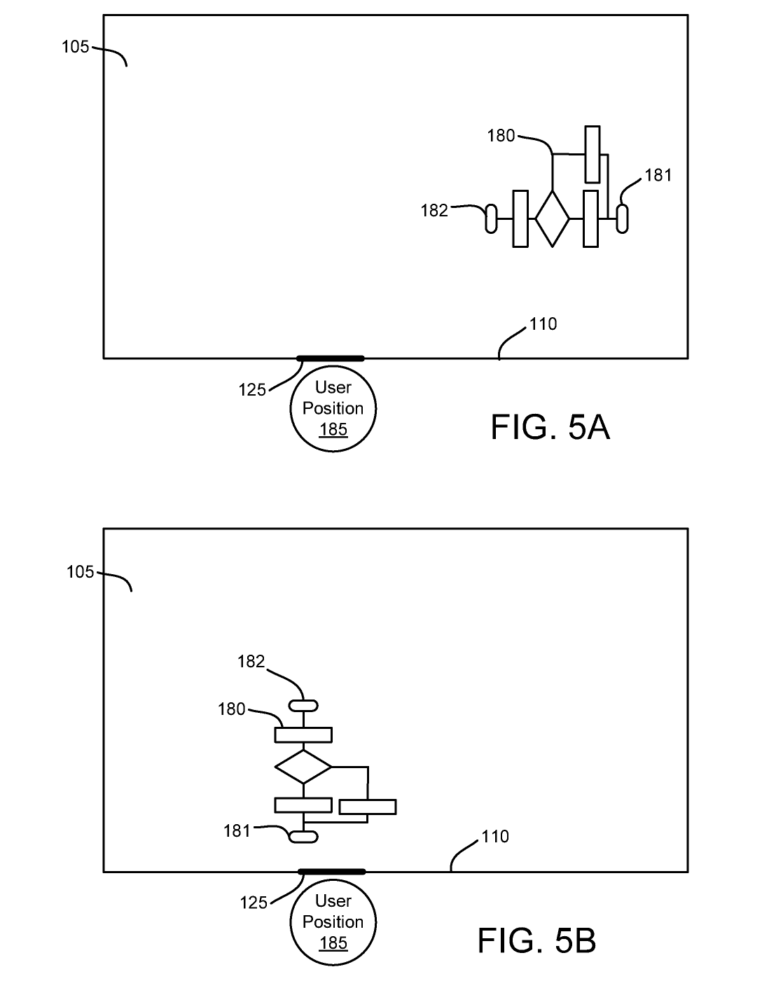

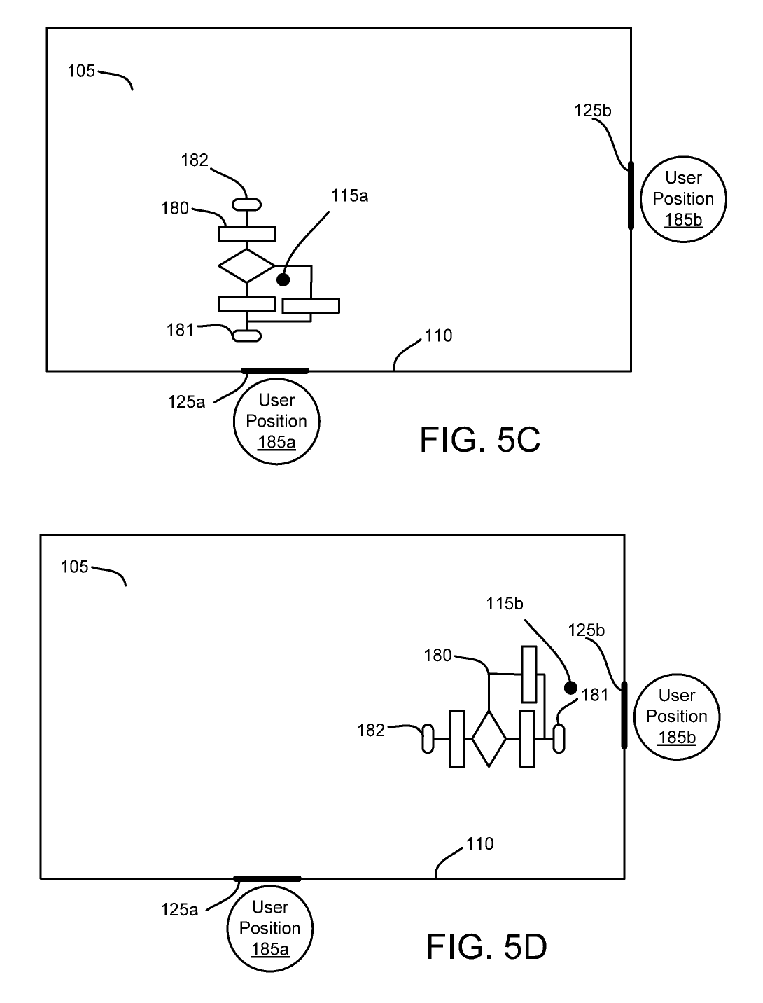

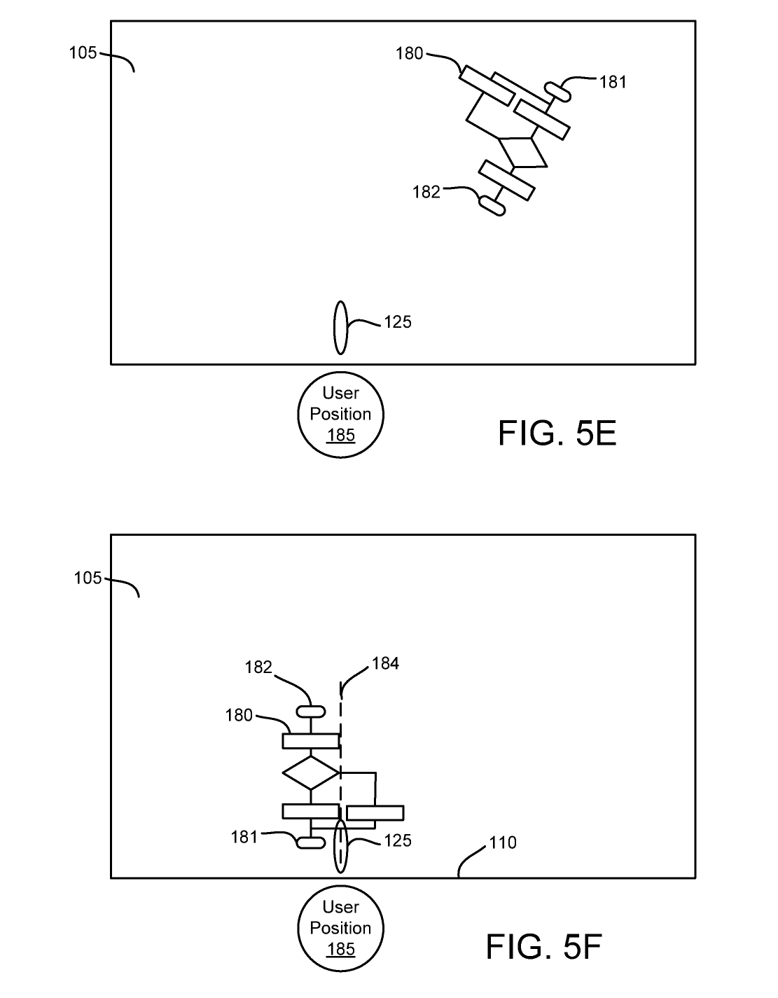

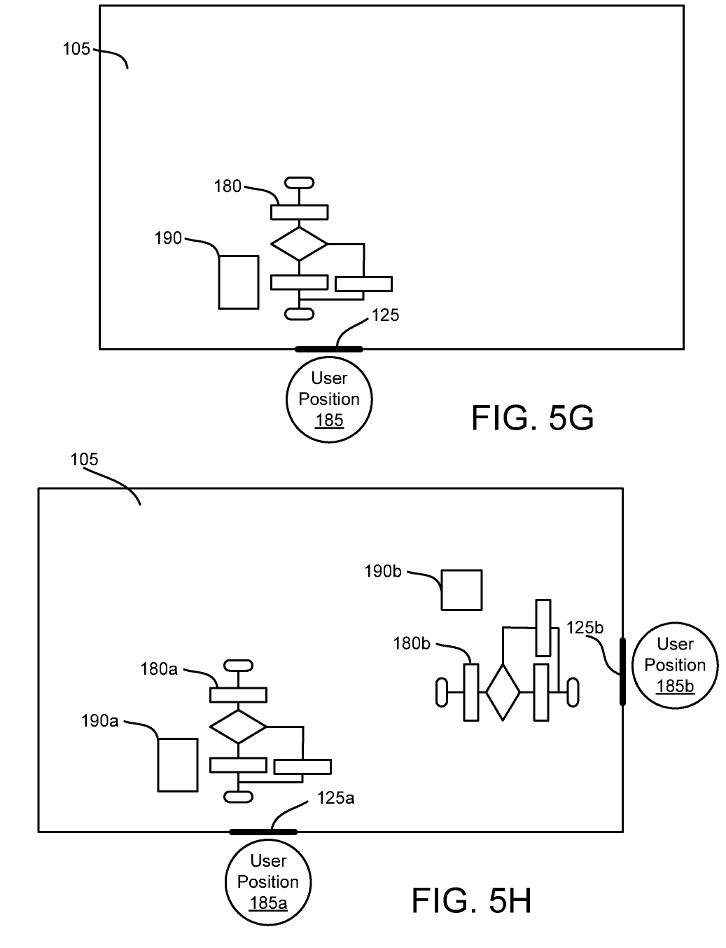

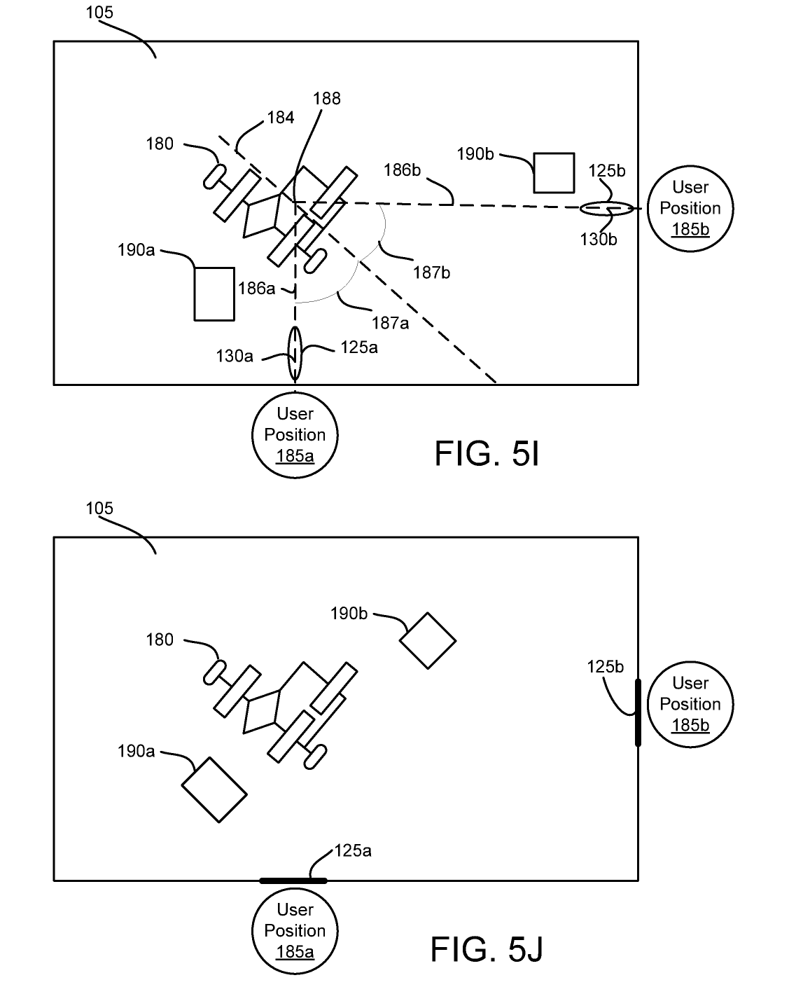

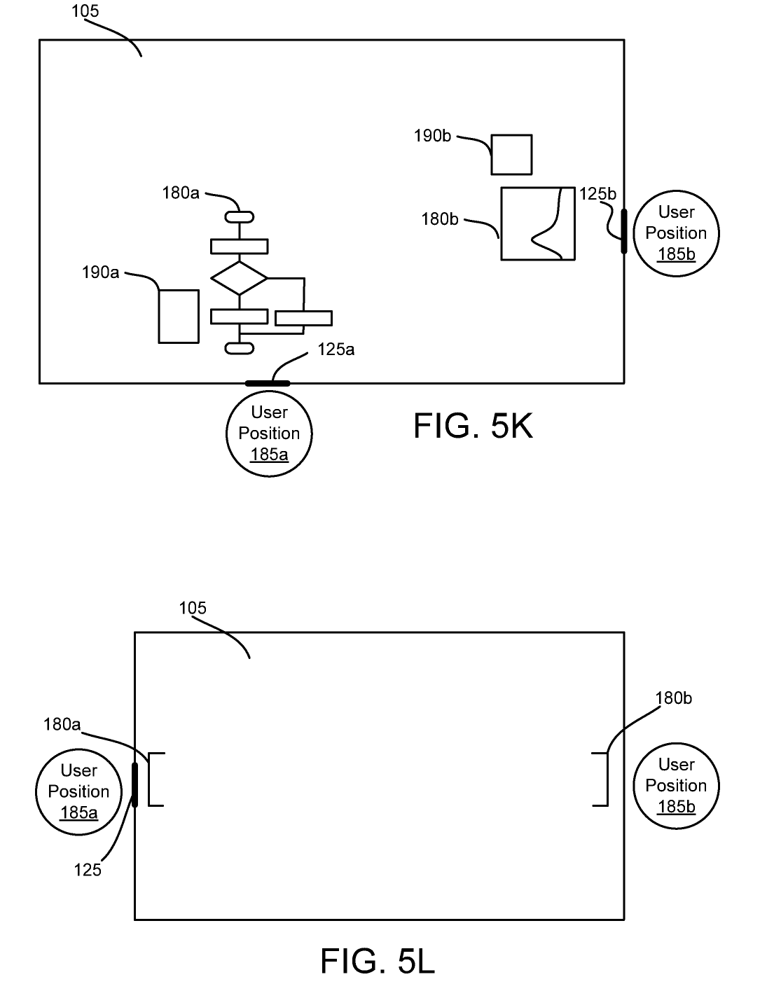

FIG. 5A is a top view drawing illustrating one embodiment of organizing display data 180 on a multiuser display 105. The multiuser display 105 may be horizontally disposed as illustrated in FIG. 1. The multiuser display 105 is depicted as displaying display data 180. Although the display data 180 is depicted as a graphical flowchart in order to more easily show the orientation, one of skill in the art will recognize that the display data 180 may be any type of data that is displayed by electronic devices including an operating system, text data, image data, video data, controls, interfaces, and the like.

In the depicted embodiment, a user is located at a user position 185. The user position 185 is adjacent to the multiuser display 105, but is on opposite edge 110 of the multiuser display 105 from the display data 180. In addition, the display data 180 is oriented away from the user position 185 rather than towards the user position 185. As used herein, display data 180 may be oriented toward the user position 185 when a bottom 181 of the display data 180 is closer to the user position 185 then a top 182 of the display data 180. In one embodiment, the bottom 181 of the display data 180 is parallel to the edge 110 adjacent to the display data 180. Thus the display data 180 may be oriented towards the user position 185 when the bottom 181 of the display data 180 is adjacent to and parallel to the edge 110 nearest to the user position 185.

FIG. 5B is a top view drawing illustrating one embodiment of organizing display data 180 on the multiuser display 105. In response to determining the user position 185 from the hover presence 125 on the multiuser display 105 as illustrated in FIG. 5A, the display data 180 is depicted as organized on the multiuser display 105 in response to the user position 185. In the depicted embodiment, the display data 180 is organized as oriented toward the user position 185.

FIG. 5C is a top view drawing illustrating one embodiment of organizing display data 180 on the multiuser display 105. In the depicted embodiment, the display data 180 is oriented towards a second user position 185b. The display data 180 may be oriented towards the first user position 185a in response to detecting first contact at a first contact location 115a.

In one embodiment, the first hover presence 125a may be on a corner of one edge 110 and the second hover presence 125b at the same corner of an adjacent edge 110. The user position 185 may be detected at the corner and the display data 180 oriented towards the user position 185 at the corner.

FIG. 5D is a top view drawing illustrating one embodiment of organizing display data 180 on the multiuser display 105. In the depicted embodiment, the display data 180 of FIG. 5C is oriented towards the second user position 185b in response to detecting the second contact at a second contact location 115b subsequent to the first contact of FIG. 5C. Thus the display data 180 is organized oriented towards the user position 185 associated with the most recent contact.

FIG. 5E is a top view drawing illustrating one embodiment of organizing display data 180 on a multiuser display 105. A hover presence 125 is depicted as being detected on the multiuser display 105. The user position 185 may be determined from the hover presence 125 on the multiuser display 105 as will be described hereafter. In addition, the display data 180 may be organized on the multiuser display 105 in response to the user position 185.

FIG. 5F is a top view drawing illustrating one embodiment of organizing display data 180 on the multiuser display 105. In response to determining the user position 185 from the hover presence 125 on the multiuser display 105 as illustrated in FIG. 5E, the display data 180 is depicted as organized on the multiuser display 105 in response to the user position 185. In the depicted embodiment, the display data 180 is organized as oriented toward the user position 185.

In one embodiment, the display data 180 is oriented towards the user position 185 when a top-to-bottom axis 184 of the display data 180 is within a specified orientation range of being directed towards the user position 185. The orientation range may be 0 to 30 degrees. Alternatively, the orientation range may be 0 to 60 degrees.

In one embodiment, the display data 180 is oriented towards the user position 185 when a bottom 181 of the display data 180 is disposed near a portion of the edge 110 of the multiuser display 105 closest to the user position 185 and the top-to-bottom axis 184 is within the specified orientation range of being directed towards the user position 185. The bottom 181 of the display data 180 may be disposed near the portion of the edge 110 of the multiuser display 105 that is closest to the user position 185 when the bottom 181 is disposed within 0 to 40 cm of the edge 110 of a horizontally disposed multiuser display 105.

FIG. 5G is a top view drawing illustrating one embodiment of organizing display data 180 on the multiuser display 105. The user position 185 and the display data 180 of FIG. 5F are depicted. In addition, the multiuser display 105 may identify the user at the user position 185 from the user identifier 235 for the hover presence 125. Organizing the display data 180 may further comprise providing user information 190 for the user.

The user information 190 may include one or more email accounts, one or more instant messaging accounts, one or more telephone interfaces, one or more video interfaces, one or more financial data interfaces, and one or more media interfaces. In one embodiment, the user information 190 includes data files, documents, data sources, and the like selected by the user. The data files, documents, data sources, and the like may reside on a remote server.

In one embodiment, organizing the display data 180 includes configuring the display data 180 and/or the user information 190 with the user preferences for the user. The user preferences may include but are not limited to language, display colors, display background, display image size, display font size, display font, and the like.

FIG. 5H is a top view drawing illustrating one embodiment of organizing display data 180 on the multiuser display 105. The multiuser display 105 of FIG. 5G is depicted with a first user at a first user position 185a. The first user position 185a may be determined from a first hover presence 125a on the multiuser display 105. First display data 180a is organized on the multiuser display 105 in response to the first user position 185a.

In addition, a second user is depicted at a second user position 185b. The second user position 185b may be determined from a second hover presence 125b. In response to the first user position 185a and the second user position 185b, the multiuser display 105 organizes the display data 180. In the depicted embodiment, a first instance of the display data 180a is oriented towards the first user position 185a while a second instance of the display data 180b is oriented towards the second user position 185b.

In the depicted embodiment, organizing the display data 180 in response to the first user position 185a and the second user position 185b includes displaying first user information 190a for the first user position 185a and displaying second user information 190b for the second user position 185b. The first user information 190a may be oriented towards the first user position 185a while the second user information 190b may be oriented towards the second user position 185b.

In addition, organizing the display data 180 in response to the first user position 185a and the second user position 185b may further include configuring the first display data 180a with first user preferences for the first user. The second display data 180b may also be configured with second user preferences for the second user.

In an alternative embodiment, the first display data 180a and the second display data 180b are configured with combined preferences that comprise both the first user preferences and the second user preferences. For example, the font size of the combined preferences may be no smaller than the largest font size of the first user preferences and the second user preferences. Similarly, the combined preferences may be set to default values for each element of the first user preferences that is not equivalent to the corresponding element of the second user preferences.

FIG. 5I is a top view drawing illustrating one embodiment of organizing display data 180 on the multiuser display 105. In the depicted embodiment, a single instance of display data 180 is organized as oriented towards both the first user position 185a and the second user position 185b. In one embodiment, the display data 180 is oriented so that a first display angle 187a between the top-to-bottom axis 184 and a first hover presence vector 130a is equivalent to a second display angle 187b between the top-to-bottom axis 184 and a second hover presence vector 130b. Alternatively, the first and second display angle's 187a-b may be between first and second edge vectors 126.

In one embodiment, the first and second hover presence vectors 130a-b and first and second edge vectors 126 are parallel to a plane of the multiuser display 105 disposed in a horizontal position. In one embodiment, the user information 190 for each user is oriented toward the user position 185 of the user.

FIG. 5J is a top view drawing illustrating one embodiment of organizing display data 180 on the multiuser display 105. The single instance of display data 180 is organized as oriented towards both the first user position 185a and the second user position 185b as shown in FIG. 5I. In addition, the first user information 190a and the second user information 190b are oriented parallel to the orientation of the display data 180.

FIG. 5K is a top view drawing illustrating one embodiment of organizing display data 180 on the multiuser display 105. In the depicted embodiment, the first display data 180a is organized as oriented towards the first user position 185a. Second display data 180b that is different from the first display data 180a is organized as oriented towards the second user position 185b. Thus a first user at the first user position 185a and the second user at the second user position 185b may concurrently view different display data 180.

FIG. 5L is a top view drawing illustrating one embodiment of organizing display data 180 on the multiuser display 105. In the depicted embodiment, first display data 180a is organized as oriented toward a first user position 185a in response to determining the first user position 185a from the hover presence 125 on the multiuser display 105.

The second user position 185b is determined relative to the first user position 185a. In addition, second display data 180b is organized as oriented toward the second user position 185b. The second user position 185b may be inferred solely from the first user position 185a.

In the depicted embodiment, first and second users are playing a game of air hockey. The first user position 185 is determined from the hover presence 125. The second user position 185b is determined relative to the first user position 185a as opposite to the first user position 185a.

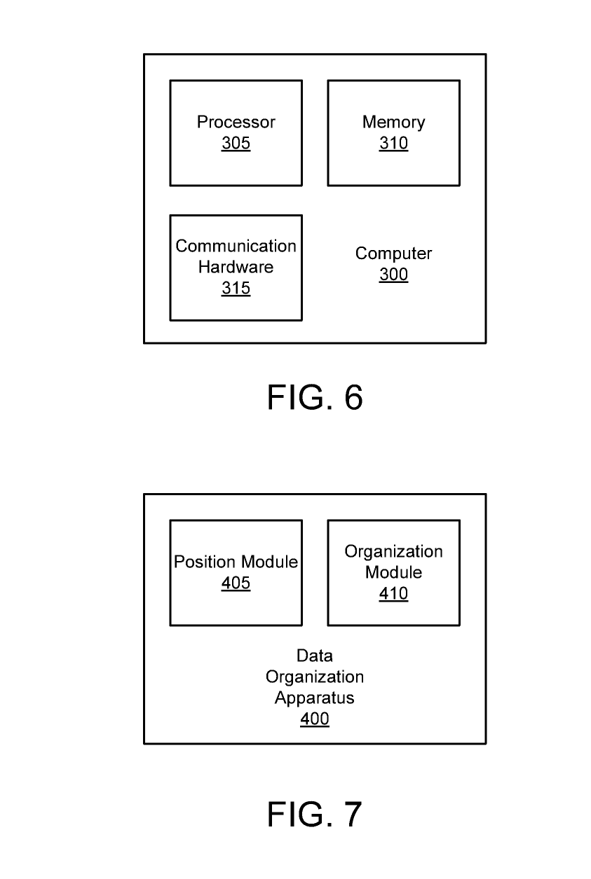

FIG. 6 is a schematic block diagram illustrating one embodiment of a computer 300. The computer 300 may be embodied in the multiuser display 105, connected to the multiuser display 105, or combinations thereof. The computer 300 includes a processor 305, a memory 310, and communication hardware 315. The memory 310 may be a semiconductor storage device, a hard disk drive, an optical storage device, a micromechanical storage device, or combinations thereof. The memory 310 may store machine readable code. The machine readable code may be executed by the processor 305 to perform one or more functions. The communication hardware 315 may communicate with other devices.

FIG. 7 is a schematic block diagram illustrating one embodiment of a data organization apparatus 400. The apparatus 400 may be embodied in the computer 300 of FIG. 6. The apparatus 400 may include a position module 405 and an organization module 410. The position module 405 and the organization module 410 may be embodied in the memory 310 storing machine readable code executable by the processor 305.

The position module 405 determines the first user position 185a from the first hover presence 125a on the multiuser display 105. The organization module 410 organizes display data 180 on the multiuser display 105 in response to the first user position 185a as will be described hereafter.

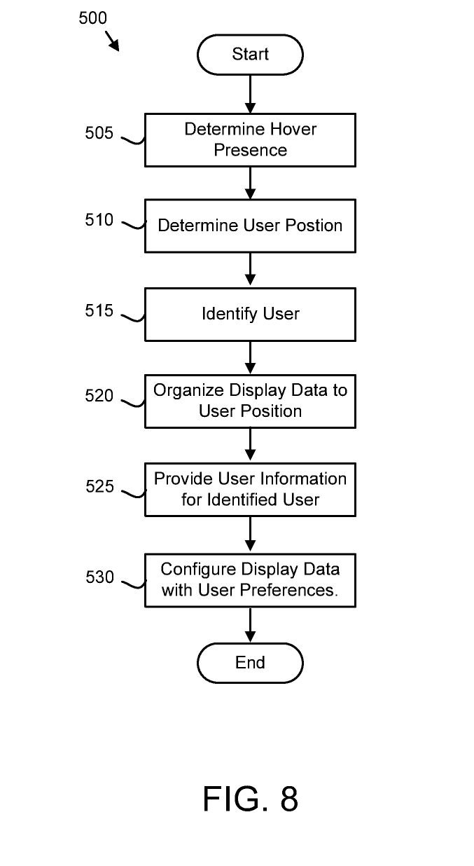

FIG. 8 is a schematic flow chart diagram illustrating one embodiment of a data organization method 500. The method 500 may perform the functions of the multiuser display 105 and the apparatus 400. In one embodiment, the method 500 is performed by the processor 305. Alternatively, the method 500 may be performed by a program product. The program product may comprise a computer readable storage medium such as the memory 310 storing machine readable code that is executable by the processor 305 to perform the operations of the method 500.

The method 500 starts, and in one embodiment, the position module 405 determines 505 the hover presence 125. In one embodiment, the hover presence 125 is determined 505 from a detection of the proximity object 120 from one or more of a capacitance detection, an electromagnetic resonance detection, an optical detection, and an acoustic detection. In one embodiment, the hover detector 175 detects the hover presence 125. The position module 405 may calculate the edge vector 126 from the hover presence 125.

In one embodiment, the position module 405 detects the contact location 115. The position module 405 may further detect and associate a hover presence 125 with the contact location 115. In one embodiment, the position module 405 determines a hover presence area for the hover presence 125. The position module 405 may also calculate the hover presence vector 130. In one embodiment, the hover presence vector 130 intersects the contact location 115. In addition, the hover presence vector 130 may be within the plane of the multiuser display 105. In a certain embodiment, the hover presence vector 130 intersects the contact location 115 and is parallel to a longitudinal axis of the hover presence area. In an alternative embodiment, the hover presence vector 130 is calculated as a best fit longitudinal axis for the hover presence area.

The position module 405 may further determine 510 the user position 185 from the hover presence 125 on a multiuser display 105. In one embodiment, the position module 405 determines 510 a plurality of user positions 185 from a plurality of hover presences 125.

If the multiuser display 105 is horizontally disposed, a user position 185 may be determined to be located adjacent a portion of the edge 110 of the multiuser display 105 with a center of the user position 185 intersecting the edge vector 126 and/or hover presence vector 130. In one embodiment, adjacent to the edge 110 of the multiuser display 105 is within 0 to 40 cm of an edge 110 of the multiuser display 105.

In an alternative embodiment, the user position 185 is determined to be located adjacent a portion of the edge 110 of the multiuser display 105 with the center of the user position 185 intersecting a vector from the contact location and offset from the hover presence vector 130 by a specified offset angle. The specified offset angle may be between 5 and 25 degrees. In one embodiment, the specified offset angle is counterclockwise from the hover presence vector 130 for a right-handed user and clockwise from the hover presence vector 130 for a left-handed user. The user identifier 235 may be used to retrieve the handedness information for the user.

For a vertically disposed multiuser display 105, the user position 185 may be determined to be located adjacent to the plane of the multiuser display 105 and intersecting a vector normal to the plane of the multiuser display 105 and intersecting the edge vector 126 and/or hover presence vector 130 and the estimated eye level of the user. As used herein, adjacent to the plane of the multiuser display 105 is between 8 to 50 cm from the plane of the multiuser display 105.

Alternatively, the first user position 185a may be along the vector normal to the multiuser display 105 and intersecting the estimated eye level and the edge vector and/or hover presence vector 130 plus a horizontal offset. The horizontal offset may be in the range of 4 to 18 cm. In one embodiment, the horizontal offset is to the left for right-handed users and to the right for left-handed users. The user identifier 235 may be used to retrieve handedness information. Alternative, the position module 405 may query the user for the handedness information.

The position module 405 may further identify 515 the user. In one embodiment, the position module 405 identifies 515 the user from a biometric measurement of the user at the contact location 115. For example, the multiuser display 105 may record a finger print of the user and identify the user from a finger print record stored in the user identifier 235. In one embodiment, the position module 405 identifies 515 a plurality of users.

In an alternate embodiment, the position module 405 may query the user at the user position 185 for the identity of the user. The user may self identify in response to the query. In one embodiment, the position module 405 records the biometric identifier for the user and stores the biometric identifier along with the user's name and/or other identifying information in the user identifier 235. The position module 405 may subsequently identify 515 the user using the biometric identifier.

For example, the biometric identifier may be a fingerprint. The user identifier 235 may include a digital representation of the fingerprint as well as the name of the user. The position module 405 may make a biometric measurement of the user's fingerprint at the contact location 115 during a subsequent use of the multiuser display 105. The position module 405 may identify 515 the user from the fingerprint.

In a certain embodiment, a video camera of the multiuser display 105 may identify the user from a biometric identification selected from a facial identification, a retinal identification, and the like. Alternatively, a microphone of the multiuser display 105 may identify the user from an audio input such as a voice pattern.

The orientation module 410 may organize 520 the display data 180 on the multiuser display 105 in response to the user position 185. In one embodiment, the display data 180 is organized as oriented toward the user position 185 as illustrated in FIG. 5B.

In an alternate embodiment, the organization module 410 may organize 520 a first instance of the display data 180a as oriented towards a first user position 185a and organize 520 a second instance of the display data 180b as oriented towards a second user position 185b as illustrated in FIG. 5H. Thus multiple users gathered around the multiuser display 105 may each be able to clearly view instances of the display data 180. In one embodiment, changes to one instance of the display data 180 are propagated to other instances of the display data 180.

The organization module 410 may organize 520 the display data 180 in response to the first user position 185a and the second user position 185b so that the display data 180 is partially oriented towards both the first user position 185a and the second user position 185b as illustrated in FIG. 5J. Thus the multiuser display 105 may display the single instance of the display data 180 for the users at both the first user position 185a and the second user position 185b. In one embodiment, the organization module 410 organizes 520 the display data 180 for a plurality of user positions 185.

The organization module 410 may further provide 525 user information 190 for the user at the user position 185. In addition, the organization module 410 may configure 530 the display data 180 with user preferences for the user and the method 500 ends.

Multiuser displays allow multiple users to cooperatively work on one more sets of display data 180. However, the large size of multiuser displays 105 and the convenient access to the multiuser displays 105 from multiple user positions 185 make it possible for the multiuser display 105 to provide the display data 180 at positions and orientations that are inconvenient to the users. Rather than restricting the user positions from which a user can work with the multiuser display 105 or requiring the users to explicitly configure the position and orientation of display data 180 on the multiuser display 105, the embodiments determine a user position 185 from the hover presence 125 and/or a combination of the contact location 115 and the hover presence 125.

After determining the user position 185 for the user of the multiuser display 105, the embodiments automatically organize the display data 180 so the display data 180 is most advantageously viewed by the user. Thus while the user is working with the multiuser display 105, the user is free to move relative to the multiuser display 105 without constantly adjusting the organization and orientation of the display data 180.

In addition, the embodiments may organize the display data 180 for multiple user positions 185. The embodiments may determine multiple user positions 185 from multiple hover presences 125 and/or combinations of contact locations 115 and hover presences 125 and organize the display data 180 for the multiple user positions 185. Thus multiple users may work with the multiuser display 105 from a variety of positions without explicitly reconfiguring the position and orientation of display data 180.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a processor;
a multiuser display accessible to the processor; and
a memory storing machine readable code executable by the processor, the machine readable code comprising:
a position module determining a first user position from a first hover presence at the multiuser display; and
an organization module organizing display data on the multiuser display in response to the first user position.

2. The apparatus of claim 1, wherein the display data is organized as oriented toward the first user position.

3. The apparatus of claim 1, wherein the first hover presence is detected by a hover detector.

4. The apparatus of claim 1, wherein the first hover presence is detected by the multiuser display.

5. The apparatus of claim 1, the position module further determining a second user position from a second hover presence and the organization module organizing the display data in response to the first user position and the second user position.

6. The apparatus of claim 1, wherein the first hover presence is detected using a detection selected from the group consisting of capacitance detection, resistive detection, optical detection, and acoustic detection.

7. The apparatus of claim 1, the position module further identifying a first user from a biometric measurement.

8. A method comprising:
determining a first user position from a first hover presence at a multiuser display; and
organizing display data on the multiuser display in response to the first user position.

9. The method of claim 8, wherein the display data is organized as oriented toward the first user position.

10. The method of claim 8, wherein the first hover presence is detected by a hover detector.

11. The method of claim 10, wherein the first hover presence comprises an edge location.

12. The method of claim 8, wherein the first hover presence is detected by the multiuser display.

13. The method of claim 12, wherein the first hover presence comprises one or more of a hover presence area and a hover presence vector.

14. The method of claim 8, further comprising determining a second user position from a second hover presence and organizing the display data in response to the first user position and the second user position.

15. The method of claim 8, wherein the display data is organized oriented towards a user position associated with a most recent contact.

16. The method of claim 8, further comprising prompting for a user identifier at the first user position and receiving the user identifier of a first user.

17. The method of claim 11, wherein the display data is provided with user information for the first user.

18. The method of claim 11, wherein the display data is configured with user preferences for the first user.

19. A program product comprising a computer readable storage medium storing machine readable code executable by a processor to perform the operations of:
determining a first user position from a first hover presence at a multiuser display; and
organizing display data on the multiuser display in response to the first user position.

20. The program product of claim 18, wherein the display data is organized as oriented toward the first user position.
